(19) United States
(12) Patent Application Publication
(10) Pub. No.: US 2026/0233797 A1
(43) Pub. Date: Aug. 13, 2026

(54) KICKSTAND SUPPORT APPARATUS

(71) Applicant: Larry Schmitz, Rosemount, MN (US)

(72) Inventor: Larry Schmitz, Rosemount, MN (US)

(21) Appl. No.: 19/051,771

(22) Filed: Feb. 12, 2025

(51) Int. Cl. B62H 3/00

(52) U.S. Cl. CPC B62H 3/00

(57) ABSTRACT

A kickstand support apparatus for supporting a kickstand of a motorcycle or similar vehicle over soft terrain includes a handle which is elongated between a grip end and a support end. A platform is pivotably coupled to the support end of the handle. A pivot mechanism couples the handle and the platform together. The pivot mechanism comprises a first pivoting member and a second pivoting member which are pivotably coupled together. The first pivoting member is coupled to the support end of the handle, and the second pivoting member is coupled to the platform. The pivot mechanism comprises a pivot lock which is selectively engageable with the first and second pivoting members to fix the first pivoting member with respect to the second pivoting member.

### (b) CROSS-REFERENCE TO RELATED APPLICATIONS

Not Applicable

### (C) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to kickstand supports and more particularly pertains to a new kickstand support for supporting a kickstand of a motorcycle or similar vehicle over soft terrain.

### (2) Description of Related Art Including Information Disclosed Under 37 CFR 1.97 and 1.98.

Placing a kickstand to a motorcycle, a moped, or a similar vehicle on soft terrain such as sand, mud, or tar can lead to the kickstand sinking into the ground or road due to the weight carried by the kickstand being concentrated in a relatively small area. It is helpful to support kickstands in such situations by placing a rigid platform beneath the kickstand which distributes the weight across the ground or road. However, it is inconvenient to reach down to the ground to place the platform, especially in instances when the user wants to remain astride the vehicle.

The prior art discloses devices which place such a platform on the end of a telescoping handle via a pivot mechanism which allows the platform to be folded up when not in use. However, the prior art fails to describe such an apparatus in which the pivot mechanism has a lock for securing the platform at a given position with respect to the handle. Such an apparatus would be advantageous in setting the platform at a desired angle prior to placing the platform beneath the kickstand.

### (h) BRIEF SUMMARY OF THE INVENTION

An embodiment of the disclosure meets the needs presented above by generally comprising a handle which is elongated between a grip end and a support end. A platform is pivotably coupled to the support end of the handle. A pivot mechanism couples the handle and the platform together. The pivot mechanism comprises a first pivoting member and a second pivoting member which are pivotably coupled together. The first pivoting member is coupled to the support end of the handle, and the second pivoting member is coupled to the platform. The pivot mechanism comprises a pivot lock which is selectively engageable with the first and second pivoting members to fix the first pivoting member with respect to the second pivoting member.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a kickstand support apparatus according to an embodiment of the disclosure showing a platform folded up against a handle.

FIG. 2 is a perspective view of an embodiment of the disclosure showing a platform extending away from the handle.

FIG. 3 is a perspective view of an embodiment of the disclosure in which a handle is shown in an extended configuration.

FIG. 4 is a detail view of a pivot mechanism of an embodiment of the disclosure.

FIG. 5 is a perspective view of an embodiment of the disclosure with a platform folded up against a handle.

FIG. 6 is a perspective view of an embodiment of the disclosure depicting a platform being spaced away from the handle.

FIG. 7 is an in-use view of an embodiment of the disclosure.

### (j) DETAILED DESCRIPTION OF THE INVENTION

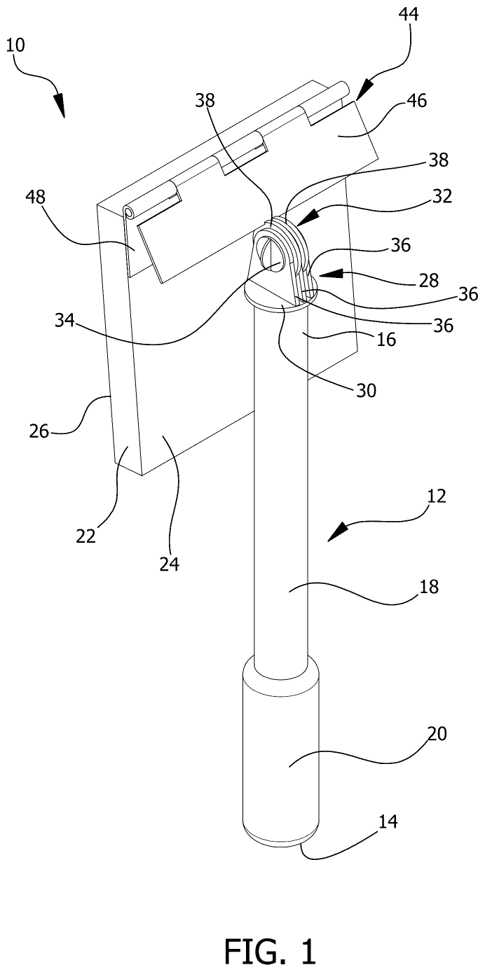

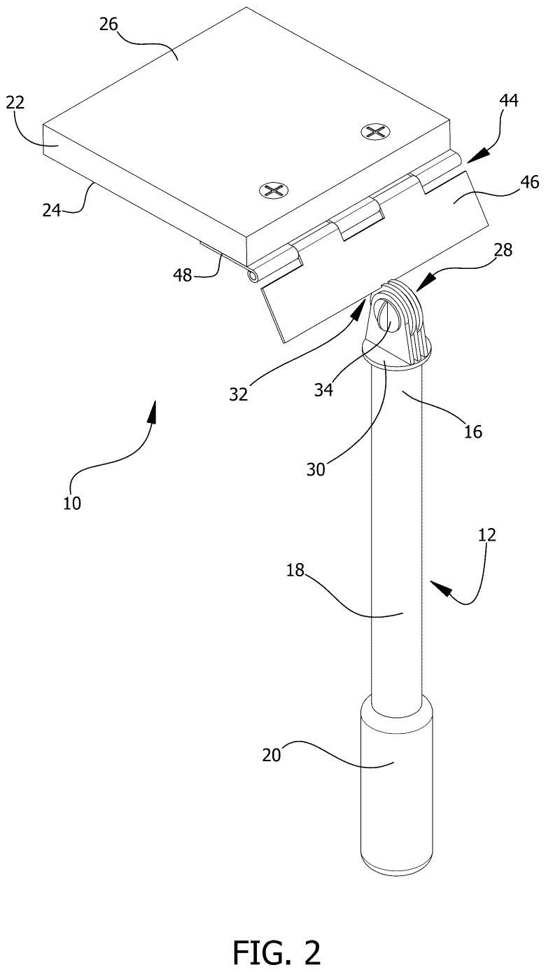

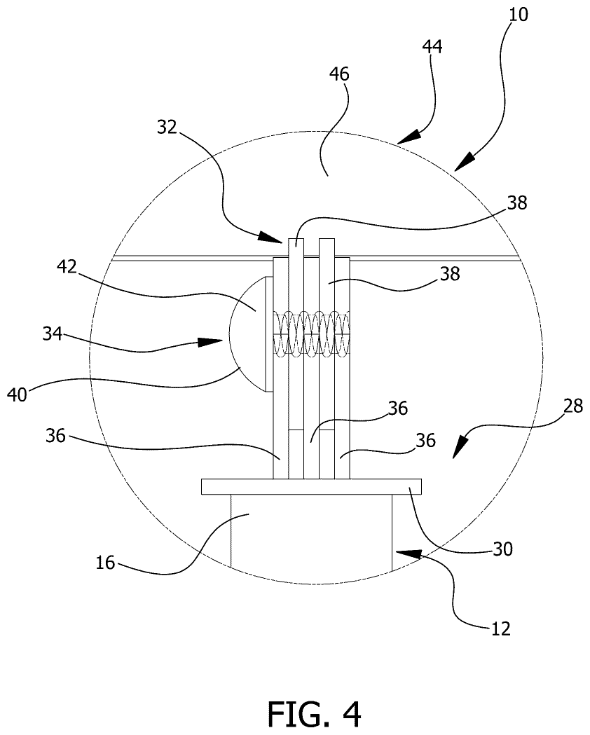

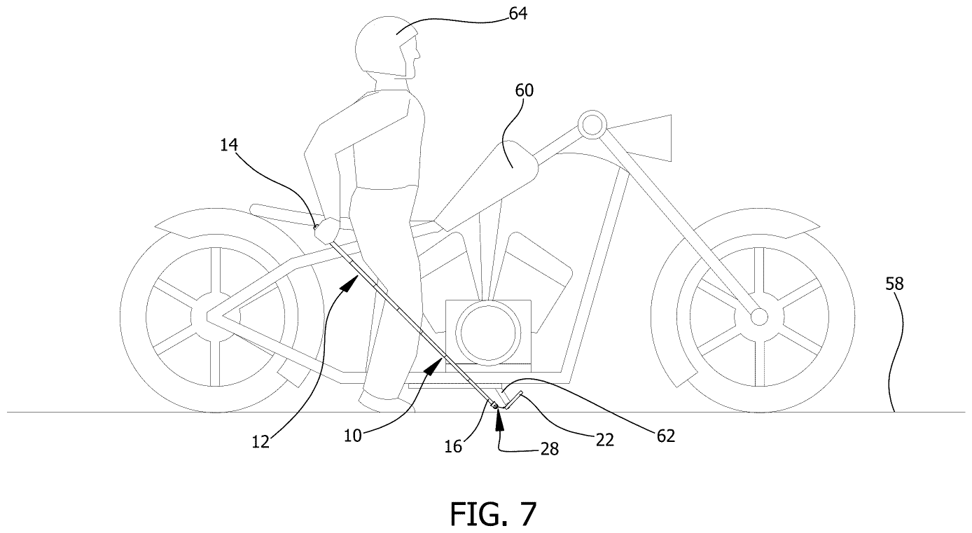

With reference now to the drawings, and in particular to FIGS. 1 through 7 thereof, a new kickstand support embodying the principles and concepts of an embodiment of the disclosure and generally designated by the reference numeral 10 will be described.

As best illustrated in FIGS. 1 through 7, the kickstand support apparatus 10 generally comprises a handle 12 which is elongated between a grip end 14 and a support end 16. The handle 12 has an adjustable length between the grip end 14 and the support end 16. The handle 12 comprises a plurality of telescoping sections 18 arranged between the grip end 14 and the support end 16 such that the handle 12 telescopically adjusts in length. However, in other embodiments, the handle 12 may comprise sections which fold together or are otherwise coupled to facilitate adjusting the length of the handle 12. A gripping member 20 is adjacent to the grip end 14 of the handle 12 which facilitates grasping the handle 12. The gripping member 20 surrounds the handle 12 and may comprise a material such as rubber or silicone to frictionally engage a hand grasping the gripping member 20.

A platform 22 is pivotably coupled to the support end 16 of the handle 12. A bottom surface 24 of the platform 22 and a top surface 26 of the platform 22 have planar shapes, and a thickness of the platform 22 between the bottom surface 24 and the top surface 26 is uniform. The top surface 26 and the bottom surface 24 have square shapes but may have any suitable planar shape such as a circle, a rectangle, or the like.

A pivot mechanism 28 couples the handle 12 and the platform 22 together and facilitates pivoting of the platform 22 with respect to the handle 12. The pivot mechanism 28 comprises a first pivoting member 30 and a second pivoting member 32 which are pivotably coupled together. The first pivoting member 30 is coupled to the support end 16 of the handle 12, and the second pivoting member 32 is coupled to the platform 22. The pivot mechanism 28 further comprises a pivot lock 34 which is selectively engageable with the first and second pivoting members 30, 32 to fix the first pivoting member 30 with respect to the second pivoting member 32.

The pivot mechanism 28 takes different forms in different embodiments. FIGS. 1-4 and 7 depict a first embodiment of the disclosure. In the first embodiment, the first pivoting member 30 comprises a plurality of first plates 36 and the second pivoting member 32 comprises a plurality of second plates 38. The first plates 36 and the second plates 38 are interleaved with each other. The pivot lock 34 comprises a bolt 40 which extends through the first plates 36 and the second plates 38. The bolt 40 is configured to clamp the first plates 36 and the second plates 38 together when rotated in a first rotational direction and to release the first plates 36 and the second plates 38 when rotated in a second rotational direction opposite the first rotational direction. The bolt 40 threads into internal threads of the furthest plate of the first plates 36 and the second plates 38 from a head 42 of the bolt 40 such that rotating the bolt 40 in the first rotational direction draws the head 42 of the bolt 40 toward the furthest plate, thereby clamping all of the first plates 36 and the second plates 38. Rotating the bolt 40 in the second rotational direction urges the bolt 40 away from the furthest plate, thereby releasing the first plates 36 and the second plates 38 from being clamped.

In similar embodiments, a nut may be used instead of mating with internal threads in the furthest plate. The head 42 of the bolt 40 defines a knob which makes rotation of the bolt 40 by hand easier. In some embodiments, the first pivoting member 30 may comprise only one first plate 36 and the second pivoting member 32 may comprise only one second plate 38. The first plate 36 and the second plate 38 in such embodiments slidably abut each other and may be clamped similarly to the first embodiment. Other locking mechanisms may secure the first pivoting member 30 to the second pivoting member 32, such as other clamps, locking pins, detents, or the like.

The first embodiment also includes a hinge 44 which couples the platform 22 to the second pivoting member 32 of the pivot mechanism 28. The hinge 44 comprises a first leaf 46 which is coupled to the second pivoting member 32 and a second leaf 48 which is coupled to the platform 22. The first leaf 46 is freely pivotable with respect to the second leaf 48. A connector may be attached to the hinge 44 to secure the hinge 44 in a folded state in which the first leaf 46 and the second leaf 48 lie against each other. The connector may be a magnet, a hook-and-loop fastener, a latch, or the like.

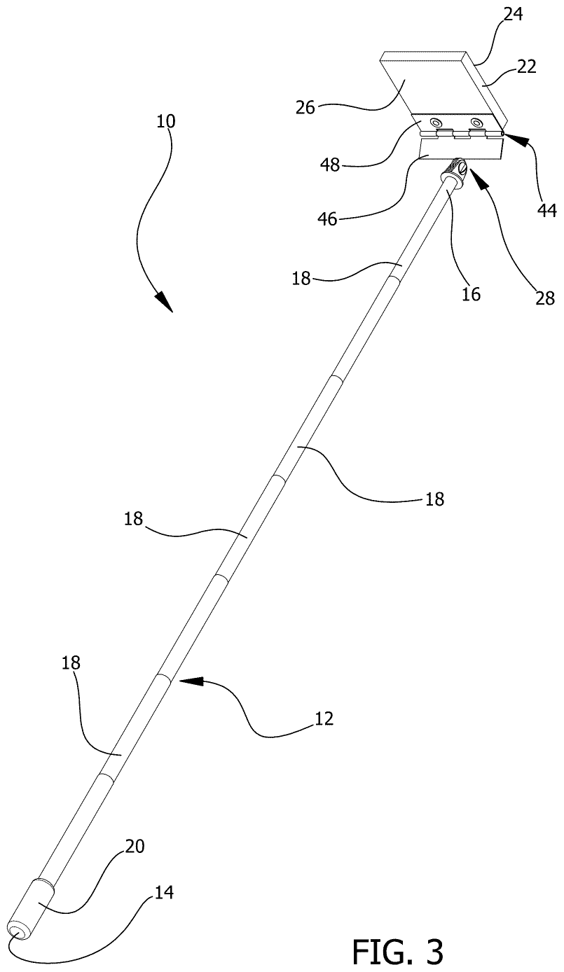

The first embodiment of the disclosure may be used by positioning the second pivoting member 32 of the pivot mechanism 28 in a selected position along a range of angles with respect to the first pivoting member 30 of the pivot mechanism 28. For example, and as shown in FIG. 3, the second pivoting member 32 is positioned such that the first leaf 46 of the hinge 44 forms an obtuse angle with the handle 12. The first pivoting member 30 and the second pivoting member 32 are then fixed by clamping them with the bolt 40 of the pivot lock 34. Secured in this manner, the handle 12 may be telescopically extended. Then the handle 12 may be positioned with the grip end 14 positioned upwardly from the support end 16, and the platform 22 may be pivoted via the hinge 44 to lean against the handle 12. A user 64 of the kickstand support apparatus 10 may be sitting astride a vehicle 60 such as a motorcycle or a moped, be standing adjacent to the vehicle 60, or otherwise suitably positioned.

The user 64 may then position the platform 22 by holding the handle 12 near the grip end 14 to place the platform 22 near a kickstand 62 of a vehicle 60. Once the platform 22 is near the kickstand 62, the platform 22 may be drawn away from the handle 12 by the user's 64 foot or by manipulating the handle 12 to urge the platform 22 into a protrusion of the vehicle 60 to set the platform 22 with the bottom surface 24 resting on a ground surface 58 near the kickstand 62. The kickstand 62 may then be set on the top surface 26 of the platform 22. If the connector described is present, the connector may keep the platform 22 pivoted upwardly from the ground surface 58 until the platform 22 is positioned as desired by the user 64, and the user 64 sets the platform 22 down via the user's 64 foot or the vehicle 60 as described above.

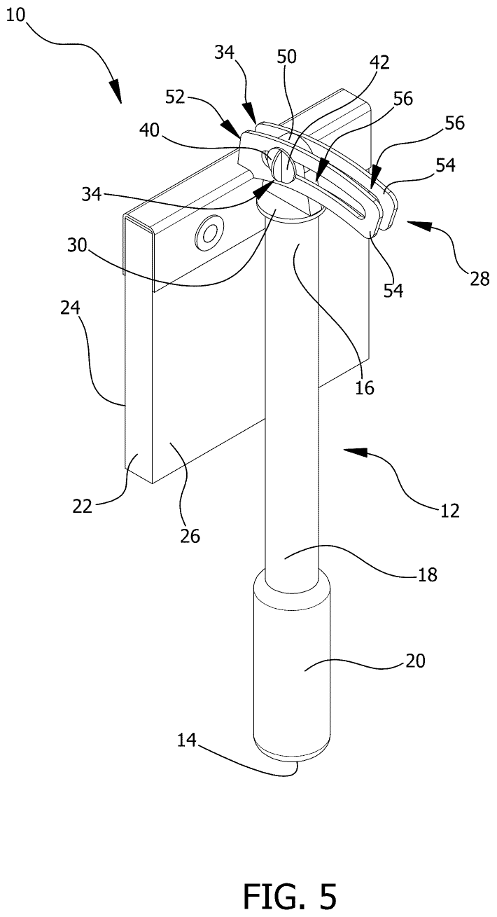

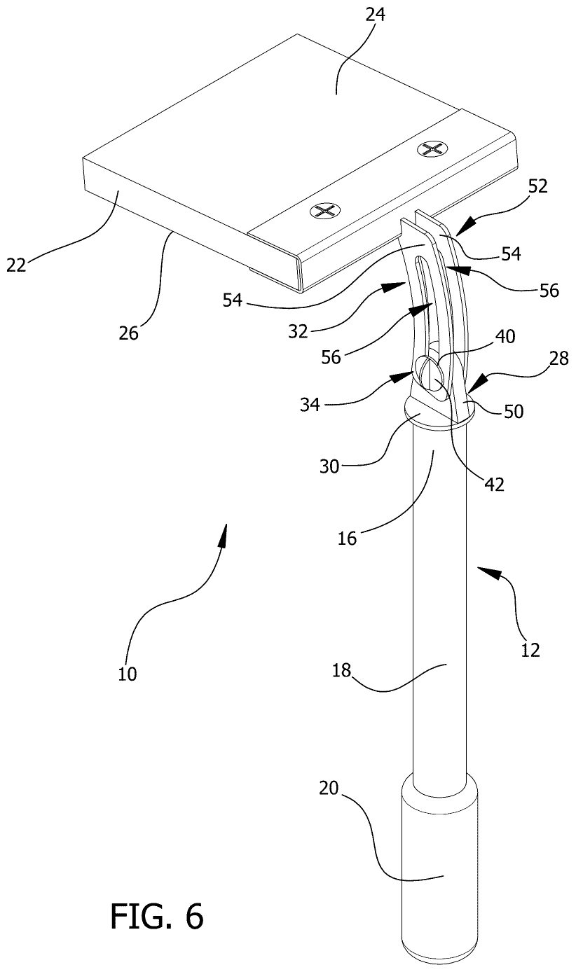

A second embodiment of the disclosure is shown in FIGS. 5-6. In the second embodiment, the first pivoting member 30 comprises a slider 50 and the second pivoting member 32 comprises a guide track 52. The slider 50 is both movable along a length of the guide track 52 and pivotable with respect to the guide track 52. The guide track 52 is coupled to the platform 22 at a periphery of the top surface 26 thereof. The guide track 52 extends away from the top surface 26 generally perpendicularly to the top surface 26. The guide track 52 comprises a pair of guide plates 54, each of which defines a slot 56 which extends therethrough. The guide plates 54 are positioned opposite each other across the slider 50. The pivot lock 34 again comprises a bolt 40 in the second embodiment. The bolt 40 is threadedly engaged to a nut (not shown) of the pivot lock 34 to selectively clamp the guide plates 54 and the slider 50 together. A head 42 of the bolt 40 defines a knob to facilitate rotation of the bolt 40 by hand.

The second embodiment may be used by positioning the slider 50 of the pivot mechanism 28 as desired by the user 64 with respect to the slots 56 of the guide plates 54, and the guide track 52 is angularly adjusted with respect to the slider 50 as desired by the user 64. The slider 50 is then fixed with respect to the guide track 52 by clamping them together via the bolt 40 of the pivot lock 34. The user 64 may then extend the handle 12 telescopically and position the platform 22 under the kickstand 62 of the vehicle 60 and onto the ground surface 58 while the user's 64 hands upon the handle 12 are positioned remotely from the kickstand 62. Again, for example, the user 64 may be sitting astride the vehicle 60, standing adjacent to the vehicle 60, or the like. Then the kickstand 62 may be set atop the platform 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A kickstand support apparatus for supporting a kickstand of a vehicle over soft terrain, the kickstand support apparatus comprising:
a handle, the handle being elongated between a grip end and a support end;
a platform pivotably coupled to the support end of the handle;
a pivot mechanism coupling the handle and the platform together, the pivot mechanism comprising a first pivoting member and a second pivoting member which are pivotably coupled together, the first pivoting member being coupled to the support end of the handle, the second pivoting member being coupled to the platform, the pivot mechanism comprising a pivot lock, the pivot lock being selectively engageable with the first and second pivoting members to fix the first pivoting member with respect to the second pivoting member.

2. The kickstand support apparatus of claim 1, wherein the handle has an adjustable length between the grip end and the support end.

3. The kickstand support apparatus of claim 2, wherein the handle comprises a plurality of telescoping sections arranged between the grip end and the support end.

4. The kickstand support apparatus of claim 1, wherein a bottom surface of the platform has a planar shape, a top surface of the platform having a planar shape.

5. The kickstand support apparatus of claim 4, wherein a thickness of the platform between the bottom surface and the top surface being uniform.

6. The kickstand support apparatus of claim 1, wherein the first pivoting member comprises a first plate, the second pivoting member comprising a second plate, the first plate and the second plate slidably abutting each other, the pivot lock being configured to clamp the first plate and the second plate together.

7. The kickstand support apparatus of claim 6, wherein the pivot lock comprises a bolt which extends through the first plate and the second plate, the bolt of the pivot lock being configured to clamp the first plate and the second plate together when rotated in a first rotational direction and release the first plate and the second plate when rotated in a second rotational direction opposite the first rotational direction.

8. The kickstand support apparatus of claim 1, further comprising a hinge coupling the platform to the second pivoting member of the pivot mechanism, the hinge comprising a first leaf and a second leaf, the first leaf being coupled to the second pivoting member of the pivot mechanism, the second leaf being coupled to the platform, the first leaf being freely pivotable with respect to the second leaf.

9. The kickstand support apparatus of claim 1, wherein the first pivoting member comprises a slider and the second pivoting member comprises a guide track, the slider being movable along a length of the guide track.

10. The kickstand support apparatus of claim 9, wherein the guide track is coupled to the platform at a periphery of the top surface thereof, the guide track extending away from the top surface generally perpendicularly to the top surface.

11. The kickstand support apparatus of claim 9, the guide track comprising a pair of guide plates, each guide plate of the pair of guide plates defining a slot which extends therethrough, the pair of guide plates being positioned opposite each other across the slider, the pivot lock comprising a bolt, the bolt of the pivot lock being configured to clamp the pair of guide plates and the slider together when rotated in a first rotational direction and release the pair of guide plates and the slider when rotated in a second rotational direction opposite the first rotational direction.

10. A kickstand support apparatus for supporting a kickstand of a vehicle over soft terrain, the kickstand support apparatus comprising:
a handle, the handle being elongated between a grip end and a support end, the handle having an adjustable length between the grip end and the support end, the handle comprising a plurality of telescoping sections arranged between the grip end and the support end;
a platform pivotably coupled to the support end of the handle, a bottom surface of the platform having a planar shape, a top surface of the platform having a planar shape, a thickness of the platform between the bottom surface and the top surface being uniform, the top surface and the bottom surface having square shapes; and
a pivot mechanism coupling the handle and the platform together, the pivot mechanism comprising a first pivoting member and a second pivoting member which are pivotably coupled together, the first pivoting member being coupled to the support end of the handle, the second pivoting member being coupled to the platform, the pivot mechanism comprising a pivot lock, the pivot lock being selectively engageable with the first and second pivoting members to fix the first pivoting member with respect to the second pivoting member.

11. The kickstand support apparatus of claim 10:
wherein the first pivoting member comprises a plurality of first plates, the second pivoting member comprising a plurality of second plates, the plurality of first plates and the plurality of second plates being interleaved with each other, the pivot lock extending through the plurality of first plates and the plurality of second plates, the first and second pivoting members being pivotable about the pivot lock, the pivot lock comprising a bolt, the bolt of the pivot lock being configured to compress the plurality of first plates and the plurality of second plates together when rotated in a first rotational direction and release from compression the plurality of first plates and the plurality of second plates when rotated in a second rotational direction opposite the first rotational direction; and
further comprising a hinge coupling the platform to the second pivoting member of the pivot mechanism, the hinge comprising a first leaf and a second leaf, the first leaf being coupled to the second pivoting member of the pivot mechanism, the second leaf being coupled to the platform, the first leaf being freely pivotable with respect to the second leaf.

12. The kickstand support apparatus of claim 10, wherein the first pivoting member comprises a slider and the second pivoting member comprises a guide track, the slider being movable along a length of the guide track, the guide track being coupled to the platform at a periphery of the top surface thereof, the guide track extending away from the top surface generally perpendicularly to the top surface, the guide track comprising a pair of guide plates, each guide plate of the pair of guide plates defining a slot which extends therethrough, the pair of guide plates being positioned opposite each other across the slider, the pivot lock comprising a bolt, the bolt of the pivot lock being configured to compress the pair of guide plates and the slider together when rotated in a first rotational direction and release from compression the pair of guide plates and the slider when rotated in a second rotational direction opposite the first rotational direction.
